(19) United States
(12) Patent Application Publication
(10) Pub. No.: US 2005/0092948 A1
(43) Pub. Date: May 5, 2005

(54) Power steering valve

(76) Inventor: Heinz-Dieter Heitzer, Heinsberg (DE)

Correspondence Address: MACMILLAN, SOBANSKI & TODD, LLC, ONE MARITIME PLAZA - FOURTH FLOOR, 720 WATER STREET, TOLEDO, OH, 43604, US

(21) Appl. No.: 10/976,683

(22) Filed: Oct. 29, 2004

(30) Foreign Application Priority Data
Oct. 29, 2003 (DE) 203 16 602.7

(51) Int. Cl. F16K 31/02

(52) U.S. Cl. 251/129.03

(57) ABSTRACT

A subassembly comprising a hydraulic power steering valve (5) and an electrical actuator (32), which can twist a component part (28) of the power steering valve, thus generating steering wheel torque superimposition.

The present invention. relates to hydraulic power steering systems for motor vehicles and, in particular, to power steering valves that are used in power steering systems of this type.

### BACKGROUND OF THE INVENTION

In road tests, it has been shown that in certain driving situations it is easier for the driver to track the vehicle if there is an active influencing of the steering wheel torque as it is haptically experienced by the driver on the steering wheel. The steering wheel torque as it is experienced by the driver can be actively influenced in an especially simple manner by using an electronically controlled electrical power steering system, because, in this case, it is simple to realize steering wheel torque. superimposition using electronic control signals. Due to the limited availability of electrical energy from the 12-volt vehicle electrical systems that are customary today, vehicles having high front-axle loads are almost exclusively equipped with hydraulic power-assisted steering systems.

The present invention is based on the objective, for vehicles having a hydraulic power steering system, of realizing cost-effective, electronically controlled steering wheel torque superimposition.

### BRIEF DESCRIPTION OF THE INVENTION

For this purpose, according to the present invention, a subassembly is provided that is made up of a hydraulic power steering valve and an electrical actuator, which can twist a component part of the power steering valve, thus generating steering wheel torque superimposition. In this manner, depending on the direction of the superimposition, there is an increase or decrease in the steering force support, steering wheel torque remaining constant, i.e., a decrease or an increase in the necessary steering wheel torque, given a constant overall steering force (the sum of the hand power of the driver and the steering force support provided by the power-assisted steering).

According to the preferred embodiment of the present invention, the power steering valve has an input shaft, an output shaft, and a valve sleeve, which is accommodated in a housing, the actuator being able to twist the valve sleeve relative to the housing. Therefore, the desired steering wheel torque superimposition can be realized by an electronically controlled offset between the input shaft and the valve sleeve.

Advantageous embodiments of the present invention will be reflected in the subclaims.

### BRIEF DESCRIPTION OF THE DRAWINGS

The present invention is described below on the basis of a preferred embodiment, which is depicted in the attached drawings. In the latter:

FIG. 1 depicts a schematic cutaway view of a subassembly according to the present invention; and

FIG. 2 schematically depicts a cutaway view along the plane II-II in FIG. 1.

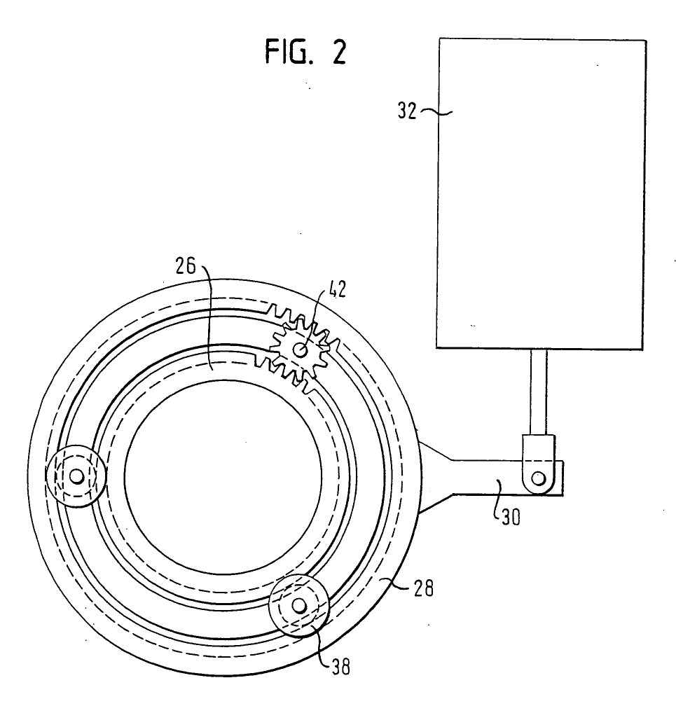

### DETAILED DESCRIPTION OF THE INVENTION

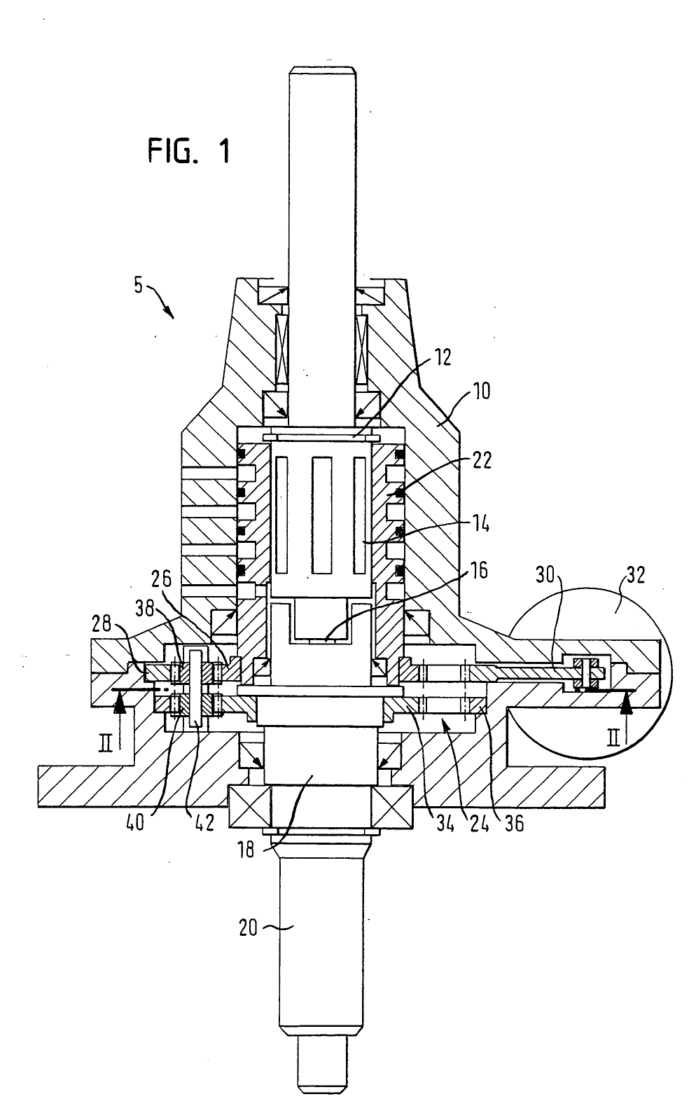

In FIG. 1, a power steering valve 5 is shown, which has a housing 10. In the housing, an input shaft 12 is rotatably supported and is provided with control grooves 14. Non-rotatably attached to input shaft 12 is one end of a torsion bar 16, whose other end is non-rotatably connected to output shaft 18. Output shaft 18 is provided with a pinion 20, which can engage in a toothed rack (not shown). The toothed rack is connected to the steerable vehicle wheels.

The segment of input shaft 12 provided with control grooves 14 is arranged in a valve sleeve 22, which, in power steering valves according to the related art, is non-rotatably coupled to output shaft 18. Due to the relative rotation between control grooves 14 of input shaft 12 and valve housing 22, a hydraulic flow provided by a pump (not shown) is controlled, such that one or the other chamber of a hydraulic cylinder is acted upon with the oil flow as a function of the relative rotation between input shaft 12 and valve sleeve 22, which is converted into the steering wheel support force. This is well known from the related art, so it is not necessary to discuss it further.

In contrast to the related art, in the power steering valve according to the present invention, valve sleeve 22 is not rigidly coupled to output shaft 18, but rather is connected to it by a gear unit 24. Gear unit 24 is formed by two planetary gears arranged next to each other, of which one is assigned to valve housing 22 and the other is assigned to output shaft 18.

A sun wheel 26 is non-rotatably connected to valve housing 22. Sun wheel 26 is surrounded by a ring gear 28, which is supported in housing 10 so as to be able to twist about a small angle. Ring gear 28 is provided with an arm 30, which an actuator 32 engages. The latter is designed as an electrical actuator, which can carry out a stroke motion. In this manner, ring gear 28 can be twisted in housing 10 by arm 30, the rotational axis of ring gear 28 coinciding with the longitudinal axis of input shaft 12 and of output shaft 18.

Arranged immediately adjoining the first planetary gear that is formed by sun wheel 26 and ring gear 28 is a second planetary gear. The latter has a sun wheel 34 that is non-rotatably connected to input shaft 18 as well as a ring gear 36 that is non-rotatably accommodated in housing 10.

In the first planetary gear, a plurality of planetary pinions 38 is arranged, and in the second planetary gear, a plurality of planetary pinions 40 is arranged. Planetary pinions 38 of the first planetary gear and planetary pinions 40 of the second planetary gear are both supported on a common axle 42. In addition, because the number of teeth and the diameter of the ring gear, the sun wheel, and the planetary pinions of the first planetary gear coincide with those of the ring gear, sun wheel, and planetary pinions of the second planetary gear, the circumferential velocity of planetary pinions 38 corresponds exactly to that of planetary pinions 40, due to the coupling by axle 42.

The planetary gear operates in the following manner: when actuator 32 arrests ring gear 28, valve sleeve 22 is non-rotatably connected to output shaft 18. Any rotation of output shaft 18 is transmitted in a conformal manner to valve sleeve 22 by sun wheel 34, planetary pinion 40, axle 42, planetary pinion 38, and sun wheel 26. The relative rotation between the input shaft and the valve sleeve of the power steering valve, and therefore the quantity and direction of the steering wheel support that is made available is a function above all of the steering wheel torque of the driver, that is transmitted via torsion bar 16. The power steering valve operates in the usual manner, which is familiar from the related art.

If an electronic control unit detects that steering wheel torque superimposition is desirable in order to assist the driver in tracking the vehicle, ring gear 28 of the first planetary gear is displaced by actuator 32 in the one or the other direction. In this way, a relative rotation inevitably results between sun wheel 26 of the first planetary gear and sun wheel 34 of the second planetary gear, because the motion of planetary pinions 38, 40, is only determined by the relative rotation between ring gear 36 of the second planetary gear and sun wheel 34 of the second planetary gear, which is fixedly connected to the valve housing. The relative rotation between both sun wheels 34, 26, leads to a twisting of valve housing 22 relative to input shaft 12, thus generating a change in the metering of the oil flows to the chambers of the hydraulic cylinder. Superimposed on the steering support determined by the deflection of torsion bar 16 is a further steering support, which is represented either as an increase or decrease in the steering force support, at a constant steering wheel torque, or as a decrease or increase of the necessary steering wheel torque, at a constant total steering force.

In contrast to the depicted embodiment, it is also conceivable to twist the other ring gear or one of the two sun wheels, using the actuator. In this manner as well, the desired offset between the input shaft and the valve sleeve can be achieved.

According to one undepicted refinement of the present invention, a centering device is provided which urges ring gear 28 into a neutral position, which is adopted when actuator 32 fails.

1. An assembly comprising a hydraulic power steering valve and an electrical actuator, which can twist a component part of the power steering valve, thus generating steering wheel torque superimposition.

2. The assembly as recited in claim 1, wherein the actuator acts upon a gear unit.

3. The subassembly as recited in claim 2, wherein the gear unit is a planetary gear.

4. The subassembly as recited in claim 3, wherein the actuator acts upon a ring gear of the planetary gear.

5. The subassembly as recited in claim 3, wherein the gear unit has a second planetary gear, the planetary pinions of the two planetary gears being rigidly connected to each other.

6. The subassembly as recited in claim 3, wherein the gear unit has a second planetary gear, the planetary pinions of the two planetary gears each rotating on a common shaft.

7. The subassembly as recited in claim 1, wherein the power steering valve has an input shaft, an output shaft, and a valve sleeve, which are accommodated in a housing, and the actuator can twist the valve sleeve relative to the housing.

8. The subassembly as recited in claim 1, wherein a torsion bar is provided, which is effective between the input shaft and the output shaft.

9. The subassembly as recited in claim 1, wherein the actuator has an electric motor, whose rotation is converted into a stroke motion.
